(19) United States
(12) Patent Application Publication
(10) Pub. No.: US 2015/0028514 A1
(43) Pub. Date: Jan. 29, 2015

(54) USE, IN THE MANUFACTURE OF A COMPOSITE COMPONENT, OF A PENETRATION OPERATION TO IMPROVE THE TRANSVERSE ELECTRIC CONDUCTIVITY OF THE COMPOSITE COMPONENT

(71) Applicant: HEXCEL REINFORCEMENTS, Dublin, CA (US)

(72) Inventors: Andrea Viard, Cremieu (FR); Jacques Ducarre, Corbelin (FR)

(73) Assignee: Hexcel Reinforcements, Dublin, CA (US)

(21) Appl. No.: 14/383,975

(22) PCT Filed: Apr. 23, 2013
(86) PCT No.: PCT/FR2013/050894

§ 371 Date: Sep. 9, 2014

(30) Foreign Application Priority Data
Apr. 27, 2012 (FR) 12 53927

(51) Int. Cl. B29C 70/54; B29C 70/48

(52) U.S. Cl. CPC B29C 70/545; B29C 70/48; B29K 2077/00
USPC 264/156

(57) ABSTRACT

The invention relates to the use, in the fabrication of a composite part formed from a stack of reinforcement materials of carbon fibres between which is sandwiched at least one layer of thermoplastic or thermosetting material or a mixture of thermoplastic and thermosetting materials, of an operation of spot application of transverse forces on at least two layers constituting the stack and positioned as neighbours in the stack, so as to successively traverse at least one reinforcement material and at least one layer of thermoplastic or thermosetting material or a mixture of thermoplastic and thermosetting materials placed in superposed position, to improve the transverse electrical conductivity of the composite part obtained.

The invention concerns the technical field of reinforcement materials adapted to the creation of composite parts. More specifically, the invention concerns a use for improving the transverse electrical conductivity of the obtained composite part.

The fabrication of composite parts or products, that is, comprising first of all one or more reinforcements or fibrous sheets, and second of all a matrix which is most often primarily the thermosetting (“resin”) type and which can include thermoplastics, may for example be achieved by a process called “direct” or “LCM” (“Liquid Composite Moulding”). A direct process is defined by the fact that one or several fibrous reinforcements are implemented in a “dry” state (that is without the final matrix), the resin or matrix being implemented separately, for instance by injection into the mould containing the fibrous reinforcements (“RTM”—Resin Transfer Moulding process), by infusion through the thickness of the fibrous reinforcements (“LRI”—Liquid Resin Infusion, or “RFI”—Resin Film Infusion process), or alternatively by manual coating/impregnation with a roller or brush on each unit layer of fibrous reinforcement, applied successively on the mould.

For the RTM, LRI or RFI processes, it is generally first necessary to build a fibrous preform of the mould of the desired finished product, then to impregnate this preform with a resin. The resin is injected or infused by differential pressure at temperature, then once all the amount of necessary resin is contained in the preform, the assembly is brought to a higher temperature to complete the polymerization/crosslinking cycle and thus harden it.

Composite parts used in the automobile, aviation, or naval industry, are particularly subject to very strict demands, notably in terms of their mechanical properties. To conserve fuel, the aviation industry has replaced many metallic materials with composite materials that are lighter. In addition, many hydraulic flight controls are replaced by electronic controls also in the interest of weight reduction.

The resin that is eventually associated, notably by injection or infusion, with the unidirectional reinforcement sheets during the creation of the part can be a thermosetting resin, such as an epoxy for instance. To allow proper flow through a preform consisting of a stack of different layers of carbon fibres, the resin is most often very fluid, for instance with a viscosity of about 50 to 200 mPa·s at the infusion/injection temperature. The major inconvenience of this type of resin is its fragility after polymerization/crosslinking, which results in poor impact resistance of the fabricated composite parts.

In order to solve this problem, the documents of previous art proposed the association of the unidirectional layers of carbon fibres to intermediate layers based on resin, and notably to a thermoplastic fibre non-woven. Solutions such as these are notably described in patent applications or patents EP 1125728, U.S. Pat. No. 6,828,016, WO 00/58083, WO 2007/015706, WO 2006/121961 and U.S. Pat. No. 6,503,856. The addition of this intermediate layer of resin, such as a non-woven, makes it possible to improve mechanical properties in the compression after impact (CAI) test commonly used to characterize the impact resistance of the structures.

In the earlier patent applications WO 2010/046609 and WO 2010/061114, the applicant has also proposed particular intermediate materials with a sheet of unidirectional fibres, particularly carbon, coupled by adhesion on each of its faces with a non-woven of thermoplastic fibres (also called non-woven), as well as their preparation process. Such composite materials consist of layers of carbon and layers of thermosetting or thermoplastic material. The carbon fibre conducts electricity, unlike the thermosetting or thermoplastic materials. The stack of these two materials is thus a stack of conductive materials and insulating materials. The transverse conductivity is thus near-zero, due to the presence of resin layers.

However, to dissipate the energy of lightning striking the fuselage or the wings, and also to assure the function of return current, the transverse electrical conductivity of composite parts used in aviation must be high. Because fuel reserves are located in the wings of planes, it is essential to successfully dissipate the electrical energy and therefore to achieve good conductivity along the axis orthogonal to the surface of the part, called the z-axis. In aircraft structures, electrical conductivity has been provided until now by the material itself, which was mostly based on aluminium. Because the new aircraft models integrate more and more composite materials, mainly based on carbon, it has become essential to provide additional conductivity to assure the functions of return current and resistance to lightning. This conductivity is achieved currently on composite parts based on carbon fibres by the local use of metallic ribbons or rovings that bind the parts to each other. Such a solution greatly increases the weight and cost of the composite solution, and is therefore not satisfactory.

Patent application WO 2011/048340 also describes the implementation of alternating thermoplastic non-woven and unidirectional sheet stacks attached to each other by spot bonds possibly accompanied by perforations. Patent application EP 2,505,342 (corresponding to WO 2011/065437) also envisages creating holes in a stack of prepregs, so as to improve interlaminar strength and combat delamination. That document also envisages inserting carbon fibre nails in the holes formed, so as to fasten the laminate that is created from the prepregs. It explains that this presence of nails inserted in the holes improves the electrical conductivity properties between the different layers of carbon fibre. It is therefore clear that in that document the creation of holes is in no way used to improve transverse electrical conductivity in the final part, because this improvement is achieved by the subsequent introduction of nails in the previously created holes. Within the context of the invention, the inventors have demonstrated a new means for obtaining composite parts with satisfactory electrical conductivity, notably in the thickness of the part not parallel to the plies composing it, even in cases where such parts are composed of a stack of reinforcement materials based on carbon fibres between which is sandwiched at least one layer of thermoplastic or thermosetting material or a mixture of thermoplastic and thermosetting materials.

The present invention relates to the use, in the fabrication of a composite part obtained from a stack of carbon fibre reinforcement materials between which is sandwiched at least one layer of thermoplastic or thermosetting material or a mixture of thermoplastic or thermosetting materials, of an operation applying spot transverse forces on at least two layers constituting the stack and positioned as neighbours in the stack, so as to successively traverse at least one reinforcement material and at least one layer of thermoplastic or thermosetting material or a mixture of thermoplastic or thermosetting materials placed in superposed position, so as to improve the transverse electrical conductivity of the composite part obtained.

Transverse conductivity can be defined as the inverse of resistivity, which is itself equal to the resistance that is multiplied by the surface and that is divided by the thickness of the part. In other words, transverse conductivity is the ability of the part to propagate and conduct electrical current within its thickness, and it can be measured by the method detailed in the examples.

The following description, with reference to the appended figures, makes it possible to better understand the invention.

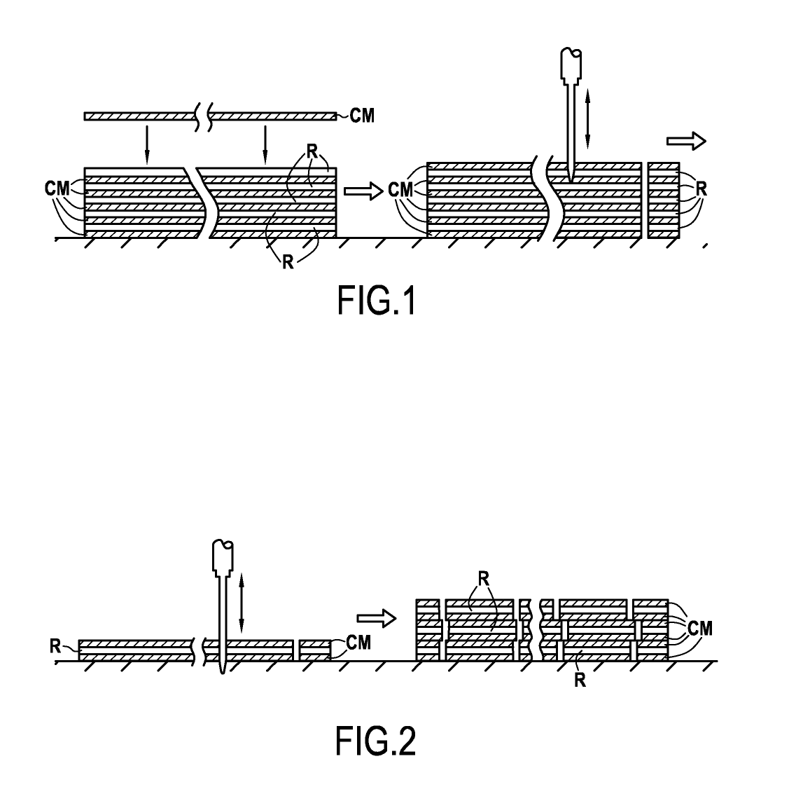

FIG. 1 is a schematic view illustrating one implementation method of the invention.

FIG. 2 is a schematic view illustrating another implementation method of the invention.

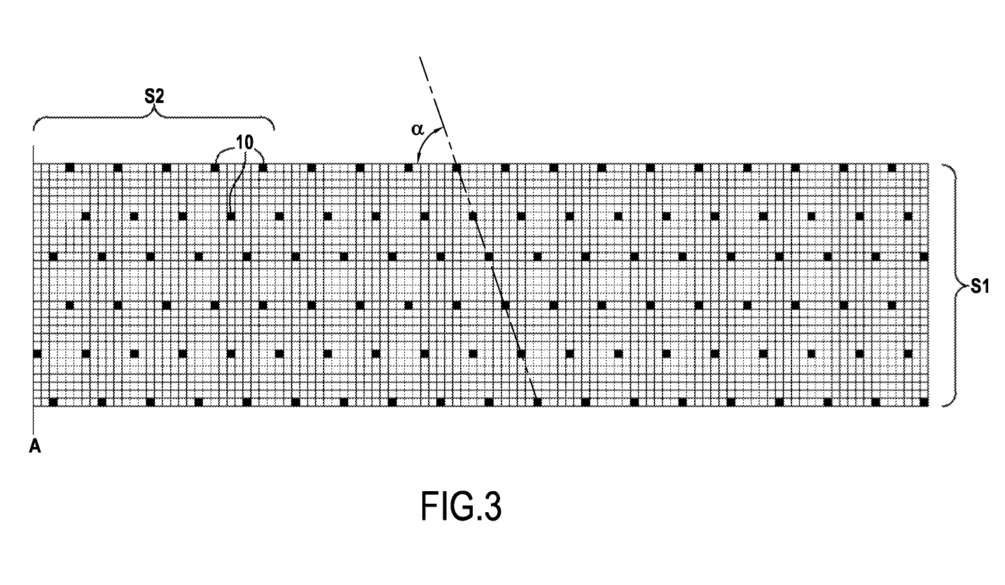

FIG. 3 is a schematic view of a series of application points where transverse forces, penetrations, or perforations are exerted.

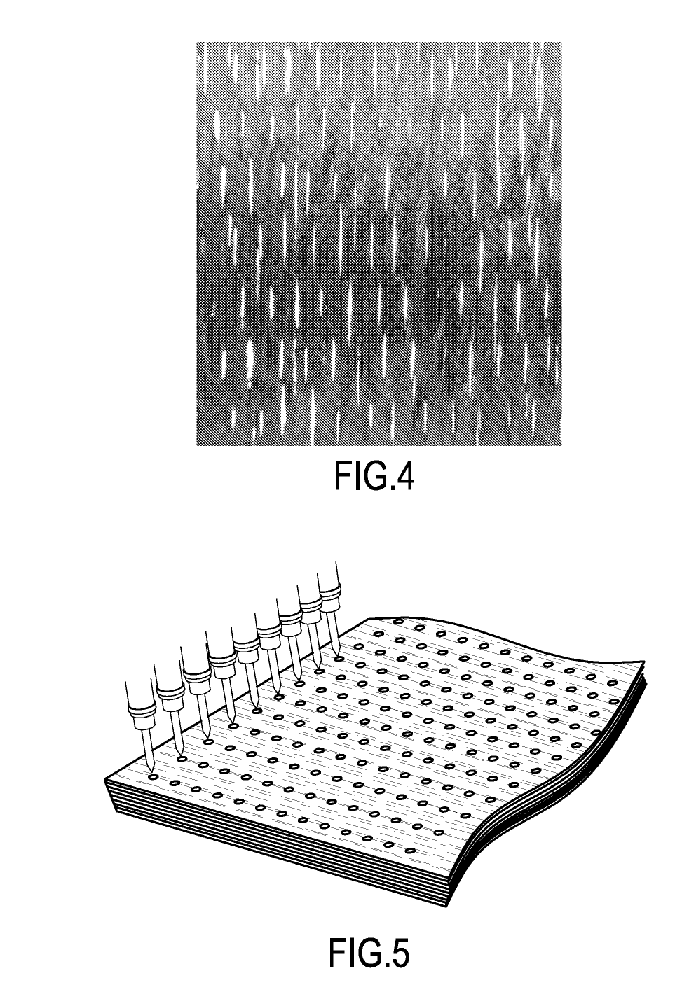

FIG. 4 (overall view and magnification at a perforation) is a photograph of a perforated intermediate material that can be used in the context of the invention.

FIG. 5 is a drawing representing a device for applying spot transverse forces.

Within the context of the invention, the operation of applying spot transverse forces corresponds to an operation of penetration at different application or penetration points. In the following description, operation of spot application of transverse forces, or operation of penetration at different points of penetration, will equally designate a step consisting of traversing at least two neighbouring layers of a reinforcement material and a layer of thermoplastic or thermosetting material.

The stack is comprised of layers of carbon fibre reinforcement material and layers of thermoplastic or thermosetting material or a mixture of such materials, which are superposed one upon another. At least one layer of thermoplastic or thermosetting material or a mixture of such materials is sandwiched between two layers of carbon fibre reinforcement material. The layer of thermoplastic or thermosetting material closest to a layer of carbon fibre reinforcement material is called the neighbouring layer of the latter. Neighbouring layers means in particular two directly adjacent layers, in other words, successively in the stack being positioned one against the other.

The operation of applying spot transverse forces is, preferably, performed by means of the penetration of a needle or of a series of needles, which makes it possible to properly control the transverse forces. Nevertheless, such an operation could very well be performed with a jet of air or water.

Of course, the device or the means used for the penetration operation is withdrawn either after passing through the stack or the portion of the stack on which the penetration operation is performed, or by following a two-way path. Improvement of electrical conductivity is achieved even after removal of such device or means, which may be of any type, contrary to the teaching of application EP 2,505,342.

The purpose and the result of this penetration are to penetrate some of the carbon fibres of a reinforcement material in the thickness of the layer of thermoplastic or thermosetting material or a mixture of the two, so that in the final part, these carbon fibres can touch the carbon fibres of the reinforcement material existing on the other side of the layer of thermoplastic or thermosetting material, thus increasing the transverse electrical conductivity of the final composite part obtained. That is why this operation is performed so as to penetrate successively a layer of carbon fibre reinforcement material and at least one layer of thermoplastic or thermosetting material or a mixture of such materials that are neighbouring it, in the position of superposition that the penetrated layers have in the final stack used for the fabrication of the composite part. In the context of the invention, it is only the operation of applying transverse forces that is used to improve conductivity. In the use according to the invention, after this application of transverse forces, no external device is inserted in the application points to achieve improvement of the electrical conductivity, contrary to what is done in application EP 2,505,342.

Advantageously, the penetration operation is performed so as to obtain a transverse electrical conductivity of at least 15 S/m, preferably of at least 20 S/m, and more preferably from 60 to 300 S/m for the composite part obtained.

Preferably, the penetration operation is performed in a direction transverse to the surface of the layers which are traversed.

It has been determined that a penetration point density of 40,000 to 250,000 per m² made it possible to obtain particularly satisfying results of transverse electrical conductivity. The penetration operation may or may not result in the creation of an opening or perforation. In a particular embodiment of the invention, which is also adapted to all implementation variants, the operation of spot application of transverse forces leaves perforations in the traversed layers. The openings created by the perforation operation most often present a circular or more or less elongated cross section in the form of an eye or slot in the plane of the traversed layers. The resulting perforations have, for example, a larger dimension in the range of 1 to 10 mm measured parallel to the traversed surface. In particular, the operation of spot application of transverse forces leads to creation of an openness factor greater than 0 and less than or equal to 8%, and preferably from 2 to 5%. The openness factor can be defined as the ratio between the surface not occupied by the material and the total area observed, that can be observed from above the material with lighting from the underside of the latter. It may, for example, be measured by the method described in the application WO 2011/086266 and is expressed in %.

The operation of spot application of transverse forces is preferably accompanied by heating that results in at least a partial fusion of the thermoplastic or thermosetting material or a mixture of the two, at the points of application of transverse forces. Preferably, this fusion occurs in all the traversed layers of the thermoplastic or thermosetting material or a mixture of the two. For this purpose, a heated penetration device will be used, for example. Such an operation allows notably the performance of welds, and to thereby fasten the perforations so that they remain, even after withdrawal of the device or of the means of penetration used to apply the transverse forces. In the absence of such heating, the reinforcement material and the layer of thermoplastic or thermosetting material or a mixture of the two could tend to tighten around the penetration point after withdrawal of the device or of the means of penetration used, so that the openness factor obtained may then correspond to the one present before the penetration operation.

The penetration operation can be performed on the stack already formed or on intermediate materials which will then be stacked to form the stack necessary for the fabrication of the composite part.

In the first case, the penetration operation will be performed so as to traverse, at each point of penetration, the total thickness of the stack. Before the operation of spot application of transverse forces, the different layers constituting the stack may be simply deposited on top of each other, without being bound to each other, or some or all of the constituent layers of the stack may be bound together, for example, by a thermobonding, stitching, or similar operation.

When intermediate materials are used, the penetration operation can be performed on the intermediate materials before they are stacked or on the stack already formed.

If the penetration operation is performed on the intermediate materials, such an operation is preferably performed on each intermediate material which will be superposed in the stack and/or, so as to traverse, at each penetration point, the total thickness of each intermediate material. Of course, sufficient tension, notably of 1.10⁻³ to 2.10⁻² N/mm will be applied, notably on the intermediate material, most often in motion, during the penetration operation, so as to allow the introduction of the chosen means or device of penetration. It is not necessary for the penetration points to be superposed on the stack of intermediate materials.

According to a preferred embodiment in the context of the invention, it is possible to form the stack by superposing intermediate materials consisting of a reinforcement material based on carbon fibres, associated on at least one of its faces with a layer of thermoplastic or thermosetting material or a mixture of the two. Such an intermediate material may consist of a reinforcement material based on carbon fibres, associated on only one of its faces or on each of its faces, with a layer of thermoplastic or thermosetting material or a mixture of the two. Such intermediate materials have their own cohesion, one or both of the layers of thermoplastic or thermosetting material or a mixture of the two being associated with the reinforcement material preferably by thermocompression, due to the thermoplastic or thermosetting nature of the layer.

A single layer of thermoplastic or thermosetting material or a mixture of the two may be located between two consecutive reinforcement materials based on carbon fibres. In this case, the stack may correspond to a (CM/R)ⁿ sequence, CM designating a layer of thermoplastic or thermosetting material or a mixture of the two, R a reinforcement material based on carbon fibres, and n designating an integer, in particular with all the layers of thermoplastic or thermosetting material or a mixture of the two present within the stack having an identical grammage. The stack may correspond to a (CM/R)ⁿ/CM sequence, CM designating a layer of thermoplastic or thermosetting material or a mixture of the two, R a reinforcement material based on carbon fibres, and n designating an integer, in particular with the outer layers of thermoplastic or thermosetting material or a mixture of the two whose grammage is equal to one-half the grammage of each of the inner layers of thermoplastic or thermosetting material or a mixture of the two. FIG. 1 illustrates the invention with such a stack in the case where the operation of spot application of transverse forces is performed on the stack after its formation.

Application WO 2011/048340 describes such stacks consisting of an alternation of unidirectional sheets of carbon, and of non-woven thermoplastic fibres which are subjected to a penetration/perforation operation. Refer to this patent application for more details. However, while in the invention the operation of penetration or perforation is performed to improve transverse conductivity of the final composite part obtained, in this patent application it is used to improve the permeability of the stack during the fabrication of the composite part, implementing a diffusion of resin within the stack.

It is also possible for two layers of thermoplastic or thermosetting material or a mixture of the two to be located between two consecutive reinforcement materials based on carbon fibres. This is notably the case when the stack is formed by superposition of intermediate materials consisting of a reinforcement material based on carbon fibres, associated on each of its faces with a layer of thermoplastic or thermosetting material or a mixture of the two.

FIG. 2 illustrates the invention in the case where a stack is formed from a reinforcement material R based on carbon fibres, associated on each of its faces with a layer of thermoplastic or thermosetting material or a mixture of the two CM, having undergone prior to its stacking, the operation of spot application of transverse forces.

In the case where the reinforcement material is a unidirectional sheet, the points of penetration will preferably be positioned to form, for example, a network of parallel lines, and be advantageously positioned on two sets of lines S1 and S2, so that:

in each S1 and S2 series, the lines are parallel to each other,

the lines of a series S1 are perpendicular to the direction A of the unidirectional fibres of the carbon sheet.

the lines of the two series S1 and S2 are secant to form between them an angle α other than 90° and in particular, of the order of 50 to 85° which is around 60° in the example shown in FIG. 3.

Such a configuration is illustrated in FIG. 3. Given that at the points of penetration 10, the penetration of a device such as a needle causes, not the formation of a hole, but rather a slot as shown in FIG. 4, because the carbon fibres spread apart from each other at the point of penetration, a shift of the slots relative to each other is thereby obtained. This makes it possible to avoid the creation of an overly large opening due to the union of two slots too closely spaced to each other.

Application WO 2010/046609 describes such intermediate materials which have undergone a prior penetration/perforation, consisting of a unidirectional carbon sheet, associated on each of its faces with a thermoplastic fibre non-woven. Refer to this patent application for more details, because it describes in detail an intermediate material and a process for fabricating composite parts that can be used as part of the invention. Here again, in this patent application, the penetration or perforation operation is performed to improve the permeability of the stack during the fabrication of the composite part. As part of the invention, such an operation is used to improve the transverse electrical conductivity of the final composite part obtained. Such an improvement is demonstrated in the examples that follow.

Within the context of the invention, regardless of the implemented variant, the operation of spot application of transverse forces will be performed by any suitable, preferably automated, means of penetration, and notably by means of a group of needles, pins or other. The diameter of the needles (in the unaltered portion after the point) will be notably 0.8 to 2.4 mm. In most cases, the application points will be spaced by 5 to 2 mm.

Most often, heating is produced at the means of penetration or around the latter, so as to harden the opening formed within the areas traversed and to thus obtain a perforation. A heating resistor may, for example, be directly integrated into the needle-like means of penetration. A fusion of the thermoplastic material or a partial or complete polymerization in the case of the thermosetting material is thus formed around the means of penetration and throughout all the layers of traversed thermoplastic or thermosetting material or mixture of the two, which leads, after cooling, to a sort of eyelet around the perforation. When the means of penetration are withdrawn, cooling is instantaneous, which makes it possible to harden the perforation obtained. Preferably, the heating device is integrated directly into the means of penetration, such that the means of penetration is itself heated.

During the penetration, the intermediate material or the stack may abut a surface which can then be heated locally around the means of penetration in order to obtain localized heating around the latter or, on the contrary, be totally isolated so as to avoid softening the closest layers of thermoplastic or thermosetting materials or a mixture of the two over their entire surface. FIG. 5 shows a means of heating/penetration equipped with an assembly of needles aligned along selected penetration lines without spacing.

The stack used in the context of the invention may comprise a large number of reinforcement materials, generally at least four and in some cases more than 100 and even more than 200. The stack will preferably consist solely of carbon fibre reinforcement materials and of layers of thermoplastic or thermosetting materials or a mixture of thermoplastic and thermosetting materials. Preferably, the carbon fibre reinforcement materials present in the stack will all be identical and the layers of thermoplastic or thermosetting material or a mixture of thermoplastic and thermosetting materials will also all be identical.

In the context of the invention, regardless of the implemented variant, the reinforcement materials composed of carbon fibres used to produce the stack are preferably unidirectional sheets of carbon fibres. Although these possibilities are not preferred, reinforcement materials such as fabrics, sewn or non-wovens (mat type) may be used.

In the context of the invention, a “unidirectional sheet of carbon fibres” means a sheet composed entirely or almost entirely of carbon fibres placed in the same direction, so as to extend essentially parallel to each other. In particular, according to a particular embodiment of the invention, the unidirectional sheet contains no weft yarn interlacing the carbon fibres, nor even stitching intended to provide cohesion to the unidirectional sheet before its stacking or association with a layer of thermoplastic or thermosetting material or a mixture of the two. In particular, this makes it possible to avoid any buckling of the unidirectional sheet.

In the unidirectional sheet, the carbon fibres are preferably not associated with a polymeric binder and are therefore designated as dry, meaning that they are neither impregnated, nor coated, nor associated with any polymeric binder before their association with the layers of thermoplastic or thermosetting material or a mixture of thermoplastic or thermosetting materials. Carbon fibres are, however, most often characterized by a high weight ratio of standard sizing that can represent at most 2% of their weight. This is particularly suitable for the production of composite parts by resin diffusion, according to the direct processes well known to those skilled in the art.

The constituting fibres of the unidirectional sheets are preferably continuous. The unidirectional sheets may consist of one, or preferably several carbon fibres. A carbon fibre consists of a group of filaments and has, in general, from 1000 to 80000 filaments, preferably 12000 to 24000 filaments. Particularly preferred for use in the context of the invention are carbon fibres of 1 to 24 K. for instance of 3K, 6K, 12K or 24K, and preferably of 12 and 24K. For example, the carbon fibres present in the unidirectional sheets have a count of 60-3800 tex, and preferentially of 400 to 900 tex. The unidirectional sheet can be created with any type of carbon fibres, for example, High Resistance (HR) fibres whose tension modulus is between 220 and 241 GPa and whose stress rupture in tension is between 3450 and 4830 MPa, Intermediate Modulus (IM) fibres whose tensile modulus is between 290 and 297 GPa and whose stress rupture in tension is between 3450 and 6200 MPa, and High Modulus (HM) fibres whose tensile modulus is between 345 and 448 GPa and whose stress rupture in tension is between 3450 and 5520 Pa (based on “ASM Handbook”, ISBN 0-87170-703-9, ASM International 2001).

In the context of the invention, regardless of the implemented variant, the stack is preferably composed of several sheets of unidirectional carbon fibres as reinforcement materials, with at least two sheets of unidirectional carbon fibres extending in different directions. All the unidirectional sheets or only some of them can have different directions. Otherwise, except for their different orientations, the unidirectional sheets will preferably have identical characteristics. The favoured orientations are most often those at an angle of 0°, +45° or −45° (corresponding equally to +135°), and of +90° with respect to the principal axis of the part to be created. The 0° orientation corresponds to the axis of the machine fabricating the stack, that is, the axis that corresponds to the direction of travel of the stack during its formation. The principal axis of the part, which is generally the largest axis of the part, generally coincides with 0°. It is, for instance, possible to form stacks that are quasi-isotropic, symmetrical, or oriented by selecting the orientation of the plies. Examples of quasi-isotropic stacking include stacking along the angles of 45°/0°/135°/90° or 90°/135°/0°/45°. Examples of symmetrical stacking include the angles of 0°/90°/0°, or 45°/135°/45°. In particular, stacks can be formed comprising more than 4 unidirectional sheets, for example 10 to 300 unidirectional sheets. These sheets may be oriented in 2, 3, 4, 5 or more different directions.

Advantageously, the carbon fibre unidirectional sheets will have a grammage of 100 to 280 g/m².

In the context of the invention, regardless of the implemented variant, the layer or layers of thermoplastic or thermosetting material or a mixture of the two used to form the stack is (are) preferably thermoplastic fibre non-woven. Although these possibilities are not preferred, layers of thermoplastic or thermosetting material or a mixture of the two such as fabrics, porous films, grids, knits or powder depositions may be used.

A non-woven, which can also be called “web”, is conventionally understood to mean a group of continuous or short randomly positioned fibres. These non-wovens or webs may for example be produced by dry processes (“Drylaid”), wet processes (“Wetlaid”), by melting (“Spunlaid”), for example by extrusion (“Spunbond”), by extrusion and blowing (“Meltblown”), or by spinning with solvent (“Electrospinning”, “Flashspinning”), well known to the person skilled in the art. In particular, the fibres composing the non-woven will have average diameters of 0.5 to 70 μm, and preferentially 0.5 to 20 μm. Non-wovens can be composed of short fibres or preferably, of continuous fibres. In the case of a short-fibre nonwoven, the fibres can for instance, have a length of 1 to 100 mm. Non-wovens offer random and preferably isotropic coverage and contribute to achieving optimal mechanical performances for the final part.

Advantageously, each of the non-wovens to be used within the stack has a surface density in the range from 0.2 to 20 g/m². Preferably, each of the non-wovens present in the stack has a thickness of 0.5 to 50 microns, preferably of 3 to 35 microns.

The layer or layers of thermoplastic or thermosetting material present in the stack, and in particular the non-woven, is (are) preferably a thermoplastic material selected from among polyamides, copolyamides, polyamides—block ether or ester, polyphthalamides, polyesters, copolyesters, thermoplastic polyurethanes, polyacetals, polyolefins C2-C8, polyethersulfones, polysulfones, polyphenylene sulfones, polyetheretherketones, polyetherketoneketones, poly(phenylene sulfide), polyetherimides, thermoplastic polyimides, liquid crystal polymers, phenoxies, block copolymers such as styrene-butadiene-methylmethacrylate copolymers, methylmethacrylate-butyl acrylate-methyl methacrylate and mixtures thereof.

The other steps used to fabricate the composite part are entirely conventional for the person skilled in the art. Notably, the fabrication of the composite part implements as final stages a diffusion step, by infusion or injection within the stack, of a thermosetting resin, a thermoplastic resin or a mixture of such resins, followed by a step of hardening the desired part with a step of polymerization/crosslinking in a cycle of defined temperature and pressure, and a cooling step. In a particular embodiment, also adapted to all the implementation variants described in connection with the invention, the diffusion, hardening and cooling steps are implemented in a closed mould.

In particular, a resin diffused within the stack will be a thermoplastic resin such as listed above for the thermoplastic material layer constituting the stack, or preferably a thermosetting resin selected from epoxides, unsaturated polyesters, vinyl esters, phenolic resins, polyimides, bismaleimides. phenol-formaldehyde resins, urea-formaldehyde, 1,3,5-triazine-2,4,6-triamines, benzoxazines, cyanate esters, and mixtures thereof. Such a resin may also include one or more hardening agents, well known to those skilled in the art for use with the selected thermosetting polymers.

In case the fabrication of the composite part uses the diffusion, by infusion or injection, of a thermosetting resin, a thermoplastic resin or a mixture of such resins within the stack, which is the major application envisaged as part of the invention, the stack formed before the addition of this external resin contains no more than 10% of thermoplastic or thermosetting material. In particular, the layers of thermoplastic or thermosetting material or a mixture of both represent from 0.5 to 10% of the total weight of the stack, and preferably from 1 to 3% of the total weight of the stack, before the addition of this external resin. Even though the invention is particularly adapted to direct process implementation, it is equally applicable to indirect processes involving prepreg-type materials.

Preferably, as part of the invention, the stack is formed in an automated fashion.

The invention will preferably use, under reduced pressure, in a closed mould, notably under a pressure below atmospheric pressure, notably less than 1 bar and preferably between 0.1 and 1 bar, an infusion into the stack of the thermosetting or thermoplastic resin or a mixture of such resins for the fabrication of the composite part.

The final composite part is obtained after a thermal treatment step. In particular, the composite part is generally obtained by a conventional hardening cycle of the polymers being used, by performing a thermal treatment recommended by the suppliers of these polymers and known to the person skilled in the art This hardening stage of the desired part is performed by polymerization/crosslinking according to a cycle of defined temperature and pressure, followed by cooling. In the case of a thermosetting resin, a gelation step of the resin will most often occur before its hardening. The pressure applied during the treatment cycle is low in the case of infusion under reduced pressure and higher in the case of injection into an RTM mould.

Advantageously, the composite part obtained has a volume fibre ratio of 55 to 70% and notably of 60 to 65%, which leads to satisfactory properties especially in the aviation field. The volume fibre ratio (VFR) of a composite part is calculated from a measurement of the thickness of a composite part, knowing the surface density of the unidirectional carbon sheet and the properties of the carbon fibre, using the following equation:

$$TVF ( \% ) = \frac{{n}_{plis} \times Masse surfacique {UD}_{carbone} }{{ρ}_{fibre carbone} \times {e}_{plaque}} \times {10}^{- 1} \qquad ( 1 )$$

Where e_{plaque} is the thickness of the plate in mm,
ρ_{carbonfibre} is the density of the carbon fibre in g/cm³,
the surface density of UD_{carbon} is in g/m².

The following examples illustrate the invention but have no limiting character.

Description of the Initial Materials:

Copolyamide web with a thickness of 118 μm and 6 g/m², sold as item 1R8D06 by the company Protechnic (Cernay, France)

Copolyamide web with a thickness of 59 μm and 3 g/m², sold as item 1R8D03 by the company Protechnic (Cernay, France),

Unidirectional sheet obtained with the fibres IMA 12K and 446 Tex from Hexcel Corporation, so as to obtain a surface density of 194 g/m².

Preparation of the Intermediate Materials

A stack of polyamide web/carbon sheet/polyamide web is formed and thermally bonded with the process described on pages 27 to 30 of the application WO 2010/046609.

The intermediate material thus obtained is then perforated with a needle assembly such as shown in FIG. 5. Each needle has a diameter of 1.6 mm in its original cylindrical portion and is heated to a temperature of 250° C. The hole density obtained corresponds to the configuration shown in FIG. 3 with a distance of 3 mm between two perforations on the lines perpendicular to the unidirectional fibres (S1 series) and 3.5 mm on the secant lines (S2 series). The tension applied to the intermediate material during the perforation is 1.7 10⁻³ N/mm.

Preparation of the Composite Parts

The material is then used to prepare a laminate as a 16-ply stack (that is to say 16 intermediate materials) and then resin is injected by an RTM process in a closed mould. The size of the panels is 340×340×3 mm for a targeted VFR of 60%. The selected stack is [0/90]4s.

The stack of 16 plies is placed into an aluminium mould and the mould is then placed under a press at 10 bars. The temperature of the assembly is then increased to 120° C. The injected resin is the RTM6 epoxy resin of the Hexcel company. The resin is preheated to 80° C. in an injection machine, and then injected into a mould with an input for the resin and one output. Once the resin is recovered at the output, the injection is stopped and the temperature of the mould is increased to 180° C. for 2 hours. During this period the mould is maintained at a pressure of 10 bars.

For comparison, multilayers prepared with unperforated intermediate materials are also produced.

Measurement of the Transverse Conductivity of the Composite Parts

Three to four 40 mm×40 mm samples are cut from the panel. The surface of each sample is sanded to expose the surface of the carbon fibres. This sanding step is not necessary if a peel ply was used for the preparation of the parts. The front and back faces of each sample are then processed by depositing a layer of conductive metal, typically gold, by sputtering, plasma treatment or vacuum evaporation. Gold or any other metal deposits must be removed from the sample field by sanding or grinding. This conductive metal deposit provides a low contact resistance between the sample and the measuring device.

A power source (30V/2A TTi EL302P programmable power supply, Thurlby Thandar Instruments, Cambridge UK) capable of varying the current and the voltage, is used to determine the resistance. The sample is brought into contact with the two electrodes of the power supply with a clamp; the electrodes must not come into contact with each other or in contact with any other metallic item. A current of 1 A is applied and the resistance is measured by two electrodes connected to a volt/ohm meter. The test is performed on each sample to be measured. The resistance value is then converted to a conductivity value using the dimensions of the sample and the following formulas:

Resistivity (Ohm.m)=Resistance (ohm)×Area (m²)/Thickness (m)

Conductivity (S/m)=1/Resistivity

The results obtained are shown in TABLE 1 below.

TABLE 1

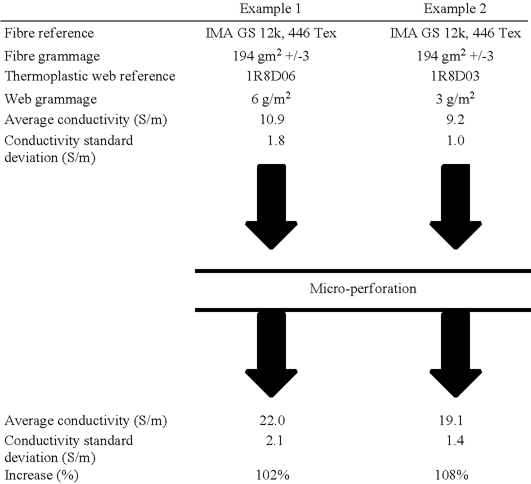

A comparison of the results with and without micro-perforation, shows that the perforation significantly increases (factor of 2) the desired transverse conductivity of the composite part obtained.

Even though the web grammages differ between the two examples, the increase is substantially identical.

1. A method for making a composite part by forming a stack of at least two reinforcement layers of carbon fibres between which is sandwiched a non-electrically conductive layer of thermoplastic or thermosetting material or a mixture of thermoplastic and thermosetting materials, said method further comprising the steps of combining said stack with an uncured resin to form a resin infused stack and then curing said resin infused stack to form said composite part, wherein said method comprises a perforation step in which the carbon fibres located in said reinforcement layers are used to form a sufficient number of electrical connections between said reinforcement layers, so as to improve the transverse electrical conductivity of said composite part, said perforation step comprising the steps of penetrating transversely through said reinforcement, layers and said non-electrically conductive layer with a needle and then removing said needle so as to form a perforation.

2. (canceled)

3. (canceled)

4. The method according to claim 1 wherein said the density of said perforations on the surface of said reinforcement layers is from 40,000 to 250,000 perforations per m².

5. (canceled)

6. A method according to claim 1 wherein the number of perforations is such that the openness factor of said reinforcement layers is from 2 to 5%.

7. The method according to claim 1 wherein said perforation step includes heating that causes at least partial fusion of the thermoplastic material or a partial or complete polymerization of the thermosetting material at said perforations.

8. The method according to claim 1 wherein the number of perforation is sufficient to obtain a transverse electrical conductivity of 60 to 300 S/m, for said composite part.

9. The method according to claim 1 wherein said perforations are positioned on lines extending parallel to each other.

10. The method according to claim 1 wherein the stack is formed from intermediate materials composed of a reinforcement layer based on carbon fibres, associated on at least one of its faces with a layer of thermoplastic or thermosetting material or a mixture of the two.

11. The method according to claim 10 wherein the stack is formed from intermediate materials composed of a reinforcement layer based on carbon fibres, associated on each of its faces with a layer of thermoplastic or thermosetting material or a mixture of the two.

12. The method according to claim 1 wherein two layers of thermoplastic or thermosetting material or a mixture of the two are located between two reinforcement layers based on carbon fibres.

13. The method according to claim 1 wherein a single layer of thermoplastic or thermosetting material or a mixture of the two is located between two consecutive reinforcement layers based on carbon fibres.

14. (canceled)

15. (canceled)

16. The method according to claim 1 wherein the perforations are formed in the stack after the stack is already formed.

17. (canceled)

18. The method according to claim 1 wherein the perforations are formed prior to formation of said stack.

19. (canceled)

20. The method according to claim 1 wherein the reinforcement layers comprise are unidirectional sheets of carbon fibres.

21. (canceled)

22. The method according to claim 20 wherein at least two sheets of unidirectional carbon fibre extend in different directions.

23. The method according to claim 1 wherein the layer of thermoplastic or thermosetting material or a mixture of thermoplastic and thermosetting materials is non-woven thermoplastic fibres.

24. The method according to claim 23 wherein the layer of non-woven thermoplastic fibres has a surface density in the range of 0.2 to 20 g/m².

25. The method according to claim 23 wherein the layer of non-woven thermoplastic fibres has a thickness of 3 to 35 microns.

26. The method according to claim 1 wherein layer said thermoplastic material is selected from the group consisting of polyamides, copolyamides, polyamides—block ether or ester, polyphthalamides, polyesters, copolyesters, thermoplastic polyurethanes, polyacetals, polyolefins C2-C8, polyethersulfones, polysulfones, polyphenylene sulfones, polyetheretherketones, polyetherketoneketones, poly(phenylene sulfide), polyetherimides, thermoplastic polyimides, liquid crystal polymers, phenoxies, block copolymers such as styrene-butadiene-methylmethacrylate copolymers, methylmethacrylate-butyl acrylate-methyl methacrylate and mixtures thereof.

27. The method according to claim 1 the layers of thermoplastic or thermosetting material or a mixture of both represent from 1 to 3% of the total weight of the stack.

28. (canceled)

29. The method according to claim 1 wherein said uncured resin is selected from the group consisting of epoxies, unsaturated polyesters, vinyl esters, phenolic resins, polyimides, bismaleimides the phenol-formaldehyde resins, urea-formaldehyde, 1,3,5-triazine-2,4,6-triamines, benzoxazines, cyanate esters, and mixtures thereof.

30. (canceled)

31. (canceled)
